(19) United States
(12) Patent Application Publication
(10) Pub. No.: US 2008/0069518 A1
(43) Pub. Date: Mar. 20, 2008

(54) Multimedia Data Receiver And Driving Method Thereof

(75) Inventor: Soon Tae Kim, Seoul (KR)

Correspondence Address: BIRCH STEWART KOLASCH & BIRCH, PO BOX 747, FALLS CHURCH, VA, 22040-0747, US

(73) Assignee: LG ELECTRONICS, Youngdungpo-ku, Seoul (KR)

(21) Appl. No.: 11/577,354

(22) PCT Filed: Nov. 16, 2005
(86) PCT No.: PCT/KR05/03884

§ 371 Date: Apr. 16, 2007

(30) Foreign Application Priority Data
Nov. 16, 2004 (KR) 10-2004-0093672

(51) Int. Cl. H04N 5/44; H04N 5/91

(52) U.S. Cl. 386/83

(57) ABSTRACT

A multimedia data receiver according to the present invention is characterized in including a blocking setting decision unit deciding whether a record-requested multimedia data is a blocking target, a user authentication processing unit processing user authentication if the record requested multimedia data is the blocking target, and a record processing unit cutting off a screen output of the record-requested multimedia data and storing the record-requested multimedia data in a record medium if the user authentication is performed.

### TECHNICAL FIELD

The present document relates to a multimedia data receiver and driving method thereof.

### BACKGROUND ART

Generally, functions of a multimedia data receiver are variously developed. For instance, a television viewer can use various supplementary information for a broadcast program receivable via broadcasting. The supplementary information of the broadcast program includes rating information of each broadcast program.

Hence, a user can set a viewing restriction for a broadcast program according to a specific rating level via a user interface provided by a television.

Namely, by setting a user-specific rating level for the viewing restriction according to an interface format provided by a television, the viewing for a broadcast program can be restricted. In television, by comparing a user setting value to a rate of a broadcast program over a current channel, a broadcast program having a level higher than the setting value is made not to be displayed or to be restrictively displayed with a user's password input.

Such a function is usually used by parents in putting limitation on children's television watching.

As the rating systems most popular in U.S.A. and the like, there are two kinds of the rating systems, as shown in FIG. 1, including the rating system for television programs established according to the EIA-766 Standard and the MPAA rating system designated to movies by MPAA.

The rates for TV programs are classified into six rates including TV-Y, TV-Y7, TV-PG, TV-14 and TV-MA.

Generally, the rating system can be classified into one type with reference to ages and the other type with reference to contents such as violence, sexuality, language and the like.

In U.S.A., the rating system with reference to ages is adopted for both TV programs and movies, which is preferred by broadcasting stations and movie companies rather than viewers.

There are 54 kinds of rate information, as shown in FIG. 2, that can be represented in the rating system having the structure shown in FIG. 1.

FIG. 2 is an exemplary diagram of rate information represented by the rating system having the structure shown in FIG. 1. There are 54 kinds of rates, each of which is explained in detail as follows.

TV-Y (All Children): A program targeting all children regardless of ages, and more particularly, infants/babies between 2˜6 ages.

TV-Y7 (Directed to Older Children): A program suitable for children over 7 ages. Contents that may spoil infants under 7 are included.

TV-G (General Audience): A program suitable for all ages. Contents with minimum violence and sexuality may be included. Abusive words are excluded.

TV-PG (Parental Guidance Suggested): A program suggesting to be viewed together with parents. Violence (TV-PG L) or sexual dialogues (TV-PG D) is included to some extent.

TV-14 (Parents Strongly Cautioned): A program unsuitable for children under 14. Violence to some extent (TV-PG V), some sexual scenes (TV-PG S), arousing scenes (TV-14 S), abusive words (TV-14 L) and blunt dialogues (TV-14 D) are included.

TV-MA (Mature Audiences Only): A program for adults to be unsuitable for ages under 17. Vivid violence (TV-MA-L) and the like are includes.

Users of the related art analog TV directly instruct children's TV viewing by referring to the above-explained ratings displayed on an upper end of a TV screen. Yet, since the recent digital broadcasting transmits rating information for a TV program, a user can automatically restrict a viewing according to the rating by a viewing restriction setting interface built in TV.

A broadcasting station establishes a rating via the rating system and then broadcasts the rated broadcast program. Parents set up a rating block value in digital TV restrictively. On a program having the set rating, audio/video mute and caption character deletion are carried out. Moreover, a channel blocking function of blocking a specific channel itself is introduced as well.

Hence, all external outputs of channel/rating blocked streams are cut off in product design, which is not regulated by the standard specifications. For instance, all 480i analog outputs (monitor output) are cut off for the channel/rating blocked stream.

However, the rating block should be released to record a stream having a specific rating set by parents. And, a situation of exposing the stream may occur while the stream is recorded.

### DISCLOSURE OF INVENTION

### Technical Problem

The object of the present invention is to provide a multimedia data receiver and driving method thereof, by which blocked multimedia data can be stored in a record medium without displaying the block multimedia data on the multimedia data receiver.

### Technical Solution

To achieve these and other advantages and in accordance with the purpose of the present invention, a multimedia data receiver includes a blocking setting decision unit deciding whether a record-requested multimedia data is a blocking target, a user authentication processing unit processing user authentication if the record-requested multimedia data is the blocking target, and a record processing unit cutting off a screen output of the record-requested multimedia data and storing the record-requested multimedia data in a record medium if the user authentication is performed.

To achieve these and other advantages and in accordance with the purpose of the present invention, a method of driving a multimedia data receiver includes; inputting a record request for a multimedia data from a user, deciding whether the record-requested multimedia data is a blocking target, if a blocking for the multimedia data is set, performing user authentication, and if the user authentication is performed, cutting off a screen output of the multimedia data and storing the multimedia data in a record medium.

### ADVANTAGEOUS EFFECTS

According to the present invention, in recording blocked multimedia data, the multimedia data can simply avoid being exposed to children or juveniles.

According to the present invention, although user authentication is performed on blocked multimedia data and although the authenticated multimedia data is cut off from a screen, the multimedia data is outputted to an output terminal to facilitate safe recording.

According to the present invention, the inconvenience of releasing a blocking to record blocked multimedia data can be reduced. It is able to prevent the blocked multimedia data from being exposed to children or juveniles at home while recording the blocked multimedia data. And, it is unnecessary for a user to stand by until the recording ends.

### BRIEF DESCRIPTION OF THE DRAWINGS

FIG. 1 is a diagram of the rating system for television programs established according to the EIA-766 Standard and the MPAA rating system designated to movies by MPAA.

FIG. 2 is an exemplary diagram of rate information represented by the rating system having the structure shown in FIG. 1.

FIG. 3 is a schematic diagram of a multimedia data receiver according to the present invention.

FIG. 4 is a flowchart of a method of recording a channel/rating blocked broadcast program in a multimedia data receiver according to the present invention.

FIG. 5 is a flowchart of a method of recording a channel/rating blocked broadcast program by adding an external terminal submenu in a multimedia data receiver according to the present invention.

FIG. 6 and FIG. 7 are exemplary diagrams for explaining a process of setting a menu and the like previously by additionally configuring an external terminal output blocking submenu on a diagram exemplarily showing a function addition to a menu in a multimedia data receiver according to the present invention.

FIGS. 8 to 10 are exemplary diagrams for explaining a functional operation inter-operating with GUI in case of employing IEEE 1394 in a multimedia data receiver according to the present invention.

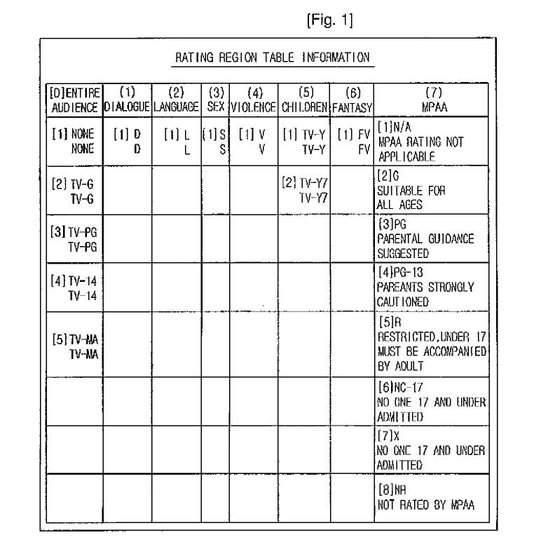

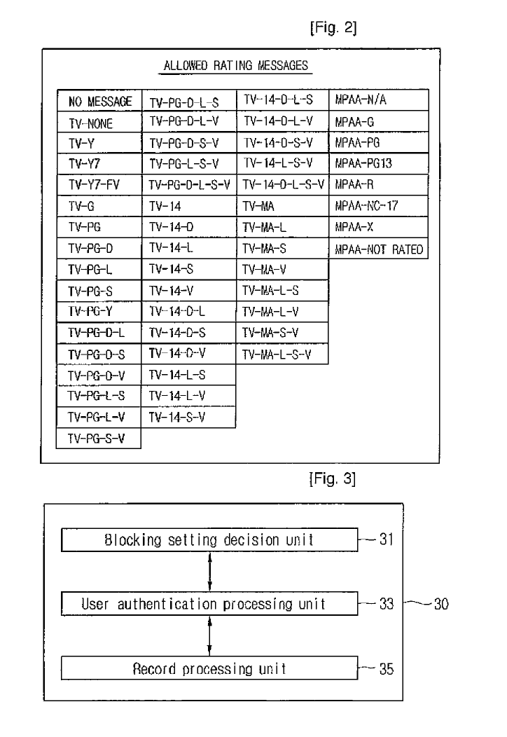

### MODE FOR THE INVENTION

Reference will now be made in detail to one preferred embodiment of the present invention, examples of which are illustrated in the accompanying drawings.

FIG. 3 is a schematic diagram of a multimedia data receiver according to the present invention.

Referring to FIG. 3, a multimedia data receiver 30 according to the present invention includes a blocking setting decision unit 31, a user authentication processing unit 33 and a record processing unit 35.

The blocking setting decision unit 310 decides whether a record-requested multimedia data is a blocking target. The blocked multimedia data includes channel blocked data and rating blocked data. The multimedia data includes moving picture data, still picture data, audio data and character data.

The user authentication processing unit 33 processes user authentication if the record-requested multimedia data is the blocking target. If the user authentication is performed, the record processing unit 35 cuts off a screen output of the record-requested multimedia data and stores the record-requested multimedia data in a record medium. The record medium includes a built-in record medium, an external record medium and a portable record medium.

A format of outputting the multimedia data to the record medium includes a composite output, a component output, an RGB output, a DVI (digital video interface) output, an HDMI (high definition multimedia interface) output, an IEEE 1394 output and a memory card output.

The multimedia data receiver according to the present invention further includes a user interface unit to receive the user authentication from a user. The user interface unit includes an appliance button, a graphic user interface (GUI) and a remote controller.

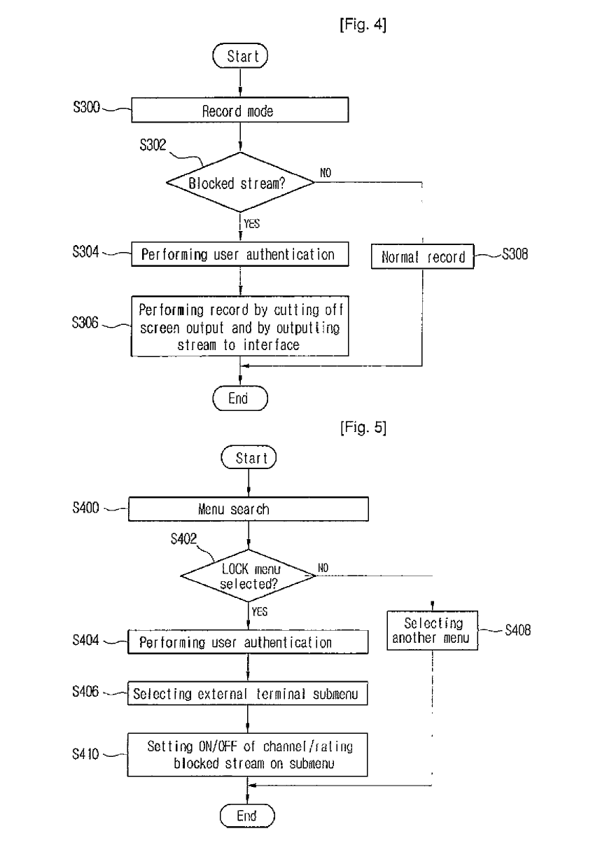

A process of recording the blocked multimedia data in the above-configured multimedia data receiver according to the present invention is explained with reference to FIG. 4 as follows. A digital TV is taken as a reference of the multimedia data receiver according to the present invention in the following description.

FIG. 4 is a flowchart of a method of recording a channel/rating blocked broadcast program in a multimedia data receiver according to the present invention.

Referring to FIG. 4, a record mode of a digital TV is set by a user to record a broadcast program of the digital TV (S300). In this case, the record mode is an instant record or a reserved record. And, the record mode can be set using an EPG (electronic program guide).

Subsequently, it is decided whether the record-mode-set broadcast program is a blocked multimedia data (S302). The blocked multimedia data may be a target having a rating blocked or a channel blocked.

If the record-mode-set broadcast program is the blocked multimedia data as a result of the step S302, user authentication receiving a password from the user is performed (S304). In this case, the user authentication can be performed through a user interface unit. And, the user interface unit includes an appliance button, a graphic user interface (GUI) and a remote controller.

Otherwise, if the record-mode-set broadcast program is not the blocked multimedia data, a normal record is carried out (S308). In this case, the normal record means that a received multimedia is stored in a record medium while an output in a digital TV is carried out. And, the output in the digital TV includes an output of a video signal through a screen and an output of an audio signal through a speaker.

Once the user authentication is performed in the step S304, the output in the digital TV is cut off and the blocked broadcast program to be recorded is outputted to an interface so that the record is performed on the record medium (S306).

The output cutoff in the digital TV means a state that the blocked broadcast program is outputted to neither the screen nor the speaker. The record medium may include a built-in record medium provided within the digital TV or an external type record medium connected to an external device. And, the record medium may include a portable record medium connected to the digital TV.

The output through the interface includes a composite output, a component output, an RGB output, a DVI (digital video interface) output, an HDMI (high definition multimedia interface) output, an IEEE 1394 output and a memory card output.

By the above-described present invention, it is able to reduce the inconvenience of releasing the channel/rating blocking in case of recording a channel/rating blocked stream.

And, it is also able to prevent the channel/rating blocked stream in being recorded from being exposed to children or juveniles at home. Moreover, it is unnecessary for a user to stand by until the recording ends.

FIG. 5 is a flowchart of a method of recording a channel/rating blocked broadcast program by adding an external terminal submenu in a multimedia data receiver according to the present invention.

Referring to FIG. 5, a main menu of a digital TV is searched by a user (S400). It is then decided whether to select a lock menu (S402).

As a result of the decision made by the step S402, if the lock menu is selected, user authentication is performed (S404). Once the user authentication is performed, an external terminal submenu set in the main menu is selected (S406).

Otherwise, if the lock menu is not selected by the used another menu except the lock menu is selected (S408).

If the external terminal submenu is selected by the user in the step 8406, video1, video2, component1, componen2, ROB, DVI and the like are turned on/off to set whether to output a corresponding stream that is channel/rating-blocked.

For instance, if a corresponding element is turned off on the submenu by the user, the corresponding element is blocked (screen blackout) so that the corresponding stream can be safely recorded without being exposed to children or juveniles.

A detailed embodiment of the present invention appealing on a screen of a digital TV is explained in detail as follows.

A video including ROB is converted to three kinds of signals of brightness (luminance signal, Y), color combination (color difference signal: Cb, Cr) and the like to be outputted to a display unit of a digital TV. A difference in quality of image is generated according to its transfer system. Thus, the difference of the output format is inevitable according to a case of combining the three signals into one to transfer, a case of dividing the three signals into two to transfer, a case of sending the three signals respectively or the like.

In this case, the output format includes a composite output combining the three signals into one to transfer, a component output, an RGB output, a DVI (digital video interface) output, an HDMI (high definition multimedia interface) output, an IEEE 1394 output and a memory card output.

In sending a channel/rating blocked stream as the output, proposed is a first method of adding a function enabling the output of the stream in a menu or remote controller. Since a digital TV employing the IEEE 1394 output format provides a GUI (graphic user interface) enabling a control of another device, a second method of operation interworking with the GUI is explained.

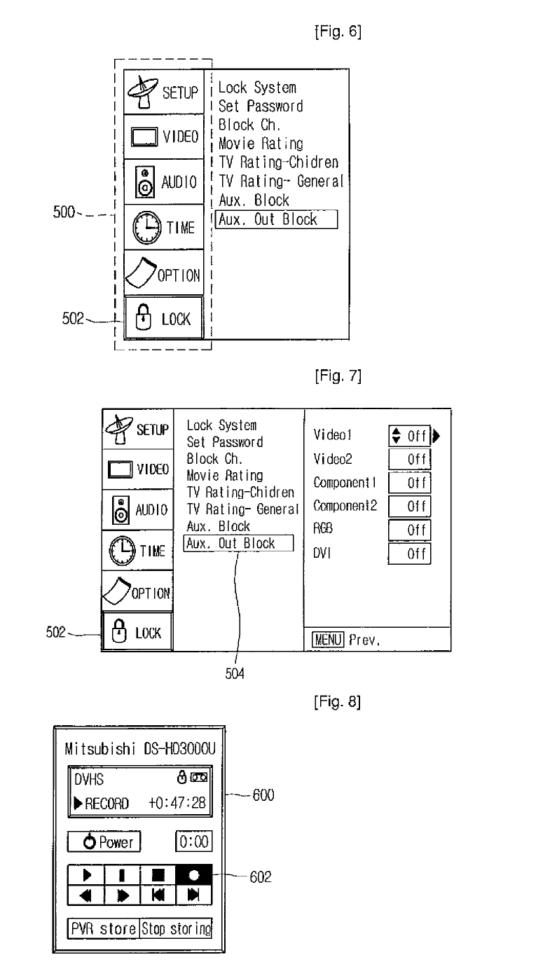

FIG. 6 and FIG. 7 are exemplary diagrams corresponding to the first method, which is applicable to a composite output, a component output, an RGB output, a DVI (digital video interface) output, an HDMI (high definition multimedia interface) output and an IEEE 1394 output. FIGS. 8 to 10 are exemplary diagrams corresponding to the second method, which is applicable to an IEEE 1394 output.

FIG. 6 and FIG. 7 are exemplary diagrams for explaining a process of setting a menu and the like previously by additionally configuring an external terminal output blocking submenu on a diagram exemplarily showing a function addition to a menu in a multimedia data receiver according to the present invention.

Referring to FIG. 6, various items such as SETUP, VIDEO, AUDIO, TIME, OPTION, LOCK 502 and the like are displayed on a main menu 500 of a digital TV to be provided to a user.

User authentication can be processed before recording to enable a record without outputting a stream to a screen using the provided main menu 500. In this case, the user authentication can be processed by selecting the LOCK item 502 from the main menu 500 and by inputting a password.

Once the password in inputted, a submenu of the LOCK item 502 can be entered,

FIG. 7 is a diagram for explaining an example of a previous setting by additionally configuring a submenu of ‘Aux.Out Block’ 504 as an example of an external terminal output blocking on the exemplary diagram of function addition to a menu according to the present invention. Once the user authentication in FIG. 6 is approved, a user selects the previously set submenu ‘Aux.Out Block’ 504.

Once the configured menu ‘Aux.Out Block’ 504 is selected, it is able to turn on/off video1, video2, component1, component2, RGB, DVI and the like. If a corresponding element is turned off, the corresponding element is blocked (screen blackout) so that the corresponding stream can be safely recorded without being exposed to children or juveniles.

A routine for the user authentication can basically employ that of the user authentication used in locking the rating or channel blocking as it is. Yet, it is un-necessary use the same authentication routine. And, it is also possible to adopt another authentication system.

FIGS. 8 to 10 are exemplary diagrams for explaining a functional operation inter-operating with GUI in case of employing IEEE 1394 in a multimedia data receiver according to the present invention.

Referring to FIG. 8, a GUI 600 provided from a digital TV employing IEEE 1394 is provided with a play button, a pause button, a stop button, a fast forward button, a reverse button, a PVR record button, a record stop button, a record button 602 and the like.

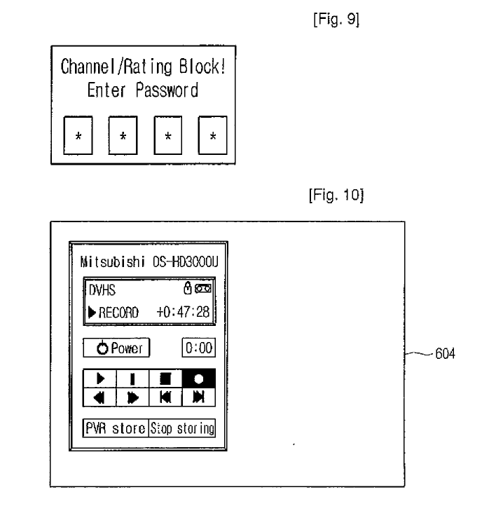

If the record button 602 is pressed by a user attempting to record a prescribed program, user authentication is tried on a channel/rating blocked stream by a control system. In this case, an image, as shown in FIG. 9, instructing a password input is displayed together with an announcement of ‘Channel/Rating Block!’.

If the user authentication is successful by a correct password inputted by the user for the screen of FIG. 9, the stream to be recorded is outputted to the IEEE 1394, which is an external interface, while the screen 604 of the digital TV is blocked (screen blackout). Such a state is shown in FIG. 10.

Hence, since the authentication can be performed in a manner of the authentication performed right before the recording, the previous setting on the menu and the like, the channel/rating blocked stream can be recorded without being exposed to children or juveniles.

### INDUSTRIAL APPLICABILITY

According to the present invention, in recording channel/rating blocked multimedia data, the multimedia data can simply avoid being exposed to children or juveniles.

According to the present invention, although user authentication is performed on channel/rating blocked multimedia data and although the authenticated multimedia data is cut off from a screen, the multimedia data is outputted to an output terminal to facilitate safe recording.

According to the present invention, the inconvenience of releasing a channel/rating blocking to record channel/rating blocked multimedia data can be reduced. It is able to prevent the channel/rating blocked multimedia data from being exposed to children or juveniles at home while recording the blocked multimedia data. And, it is unnecessary for a user to stand by until the recording ends.

1. A multimedia data receiver comprising:
a blocking setting decision unit deciding whether a record-requested multimedia data is a blocking target;
a user authentication processing unit processing user authentication if the record-requested multimedia data is the blocking target; and
a record processing unit cutting off a screen output of the record-requested multimedia data and storing the record-requested multimedia data in a record medium if the user authentication is performed.

2. The multimedia data receiver of claim 1, wherein the record medium includes a built-in record medium, an external type record medium and a portable record medium.

3. The multimedia data receiver of claim 1, wherein the blocked multimedia data includes a channel blocked multimedia data and a rating blocked multimedia data.

4. The multimedia data receiver of claim 1, wherein a format of outputting the multimedia data to the record medium includes a composite output, a component output, an RGB output, a DVI (digital video interface) output, an HDMI (high definition multimedia interface) output, an IEEE 1394 output and a memory card output.

5. The multimedia data receiver of claim 1, further comprising a user interface unit to receive a user authentication input from a user.

6. The multimedia data receiver of claim 5, wherein the user interface unit includes an appliance buttons a graphic user interface (GUI) and a remote controller.

7. The multimedia data receiver of claim 1, wherein the record-requested multimedia data is a digital broadcast program.

8. The multimedia data receiver of claim 7, wherein if the record-requested multimedia data is a digital broadcast program, the record request is set via an EPG (electronic program guide).

9. The multimedia data receiver of claim 1, wherein the record request includes an instant record and a reserved record.

10. The multimedia data receiver of claim 1, wherein the user authentication is given by a LOCK item of a main menu displayed on a screen and wherein an output format to the record medium is selected from a submenu of the LOCK item by a user.

11. A method of driving a multimedia data receiver, comprising:
inputting a record request for a multimedia data from a user;
deciding whether the record-requested multimedia data is a blocking target;
if a blocking for the multimedia data is set, performing user authentication; and
if the user authentication is performed, cutting off a screen output of the multimedia data and storing the multimedia data in a record medium.

12. The method of claim 1, wherein the record medium includes a built-in record medium, an external type record medium and a portable record medium.

13. The method of claim 1, wherein the blocking-set multimedia data includes a channel blocked multimedia data and a rating blocked multimedia data.

14. The method of claim 11, wherein a format of outputting the multimedia data to the record medium includes a composite output, a component output, an RGB output, a DVI (digital video interface) output, an HDMI high definition multimedia interface) output, an IEEE 1394 output and a memory card output.

15. The method of claim 11, wherein in performing the user authentication, a password is inputted via a user interface unit by the user.

16. The method of claim 15, wherein the user interface unit includes an appliance button, a graphic user interface (GUT) and a remote controller.

17. The method of claim 11, wherein the record-requested multimedia data is a digital broadcast program.

18. The method of claim 17, wherein if the record-requested multimedia data is a digital broadcast program, the record request is set via an EPG (electronic program guide).

19. The method of claim 11, wherein the record request includes an instant record and a reserved record.

20. The method of claim 11, wherein the user authentication is given by a LOCK item of a main menu displayed on a screen and wherein an output format to the record medium is selected from a sub menu of the LOCK item by a user.
